(19) United States
(12) Patent Application Publication
(10) Pub. No.: US 2024/0427669 A1
(43) Pub. Date: Dec. 26, 2024

(54) SYSTEM AND METHOD FOR DYNAMIC SCHEDULING OF BACKUPS IN SCALE-OUT COMPUTE ENVIRONMENTS

(71) Applicant: Druva Inc., Santa Clara, CA (US)

(72) Inventors: Srikiran Gottipati, Patamata Lanka (IN); Preethi Srinivasan, Sunnyvale, CA (US)

(21) Appl. No.: 18/617,386

(22) Filed: Mar. 26, 2024

(30) Foreign Application Priority Data
Jun. 23, 2023 (IN) 202341042005

(51) Int. Cl. G06F 11/14

(52) U.S. Cl. CPC G06F 11/1461; G06F 11/1464; G06F 2201/84

(57) ABSTRACT

A data management system may schedule data backup operations. The system receives a request for backing up data stored in one or more disks in a data source and identifies one or more proxy slots for backing up the data. For at least one of the disks, the system maps the disk to each of the one or more proxy slots and maps each mapped proxy slot to a data store of the one or more data stores. The system estimates a scan duration time for backing up data from the disk using each mapped proxy slot with each mapped data store corresponding to the mapped proxy slot, selects a proxy slot based in part on the estimated scan duration time as the backup proxy slot for the disk, and instructs the selected proxy slot for backing up the data from the corresponding disk.

### CROSS-REFERENCE TO RELATED APPLICATION

This application claims benefit of Indian Application No. 202341042005, filed Jun. 23, 2023, which is herein incorporated by reference in its entirety.

### TECHNICAL FIELD

The disclosed embodiments are related to data management systems, and, more specifically, to scheduling of backups in scale-out computing environments.

### BACKGROUND

To protect against data loss, organizations may periodically back up data to a backup system and restore data from the backup system. A data management provider may provide backup services to various organizations. The data management provider may handle a large number of backup requests that involve a tremendous amount of data. While data management providers conventionally attempt to keep track of the data, such as by relaying the time elapsed since start of backup, the current method does not provide an estimate of how long the backup is expected to run. Some method is often inaccurate because it requires many events of the historical backups to create a dataset and does not factor in the current dynamically changing environment. Other options miss out the signals in the dynamic environment in which the backup is happening that influences the time to completion for the backup, and thus often leading to inaccuracy.

### SUMMARY

In some embodiments, a computer-implemented method for scheduling data backup operations is described. A data management system may schedule data backup in one or more data stores. The system receives a request for backing up data stored in one or more disks in a data source and identifies one or more proxy slots for backing up the data. For at least one of the disks, the system maps the disk to each of the one or more proxy slots and maps each mapped proxy slot to a data store of the one or more data stores. The system estimates a scan duration time for backing up data from the disk using each mapped proxy slot with each mapped data store corresponding to the mapped proxy slot, selects a proxy slot based in part on the estimated scan duration time as the backup proxy slot for the disk, and instructs the selected proxy slot for backing up the data from the corresponding disk.

### BRIEF DESCRIPTION OF THE DRAWINGS

Figure (FIG.) 1 is a block diagram illustrating an example system environment, in accordance with some embodiments.

FIG. 2 is a block diagram that illustrates an example architecture of a scheduling engine, in accordance with some embodiments.

FIG. 3 is a block diagram that illustrates an example architecture of an estimator, in accordance with some embodiments.

FIG. 4A illustrates an example available bandwidth estimator, in accordance with some embodiments.

FIG. 4B illustrates another example available bandwidth estimator, in accordance with some embodiments.

FIG. 4C illustrates an example differential dark load estimator, in accordance with some embodiments.

FIG. 4D illustrates another example differential dark load estimator, in accordance with some embodiments.

FIG. 5 illustrates a structure of an example neural network, in accordance with some embodiments.

FIG. 6 is an example process of scheduling data backup in one or more data stores, in accordance with some embodiments.

FIG. 7 is a block diagram illustrating components of an example computing machine, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures (FIGs.) and the following description relate to preferred embodiments by way of illustration only. One skilled in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example System Environment

Figure (FIG.) 1 is a block diagram illustrating a system environment 100 of an example data management system that may be used for scheduling backup operations, in accordance with some embodiments. By way of example, the system environment 100 may include one or more data sources 110, a data management system 120, a data store 130, a metadata store 140, a network 170, and one or more proxies 160. In various embodiments, the system environment 100 may include fewer and additional components that are not shown in FIG. 1.

The various components in the system environment 100 may each correspond to a separate and independent entity or some of the components may be controlled by the same entity. For example, in some embodiments, the data management system 120 and the data store 130 may be controlled and operated by the same data storage provider company while the data source 110 may be controlled by an individual client. In another embodiment, the data management system 120 and the data store 130 may be controlled by separate entities. For example, the data management system 120 may be an entity that utilizes various popular cloud data service providers that operate the data stores 130. The components in the system environment 100 may communicate through the network 170. In some cases, some of the components in the environment 100 may also communicate through local connections. For example, the data management system 120 and the data store 130 may communicate locally as local servers, or may communicate remotely in the state-of-the-art Cloud storage environment.

A data source 110 may be one or more computing devices whose data will need to be backed up. The data source 110 can be a client device, a client server, a client database, a virtual machine, a local backup device (e.g., NAS) or another suitable device that has data to be backed up. In some embodiments, the data source 110 may send a request to store, read, search, delete, modify, and/or restore data stored in the data store 130. Data from a data source 110 may be captured as one or more snapshots. Individual file blocks of the data in those snapshots may be stored in the data store 130. A client that uses the data source 110 to perform such operations may be referred to as a user or an end user of the data management system 120. The data source 110 also may be referred to as a user device, an end user device, a virtual machine, and/or a primary source, depending on the type of data source. In the system environment 100, there can be different types of data sources. For example, one data source 110 may be a laptop of an enterprise employee whose data are regularly captured as backup snapshots. Another data source 110 may be a virtual machine. Yet another data source 110 may be a server in an organization.

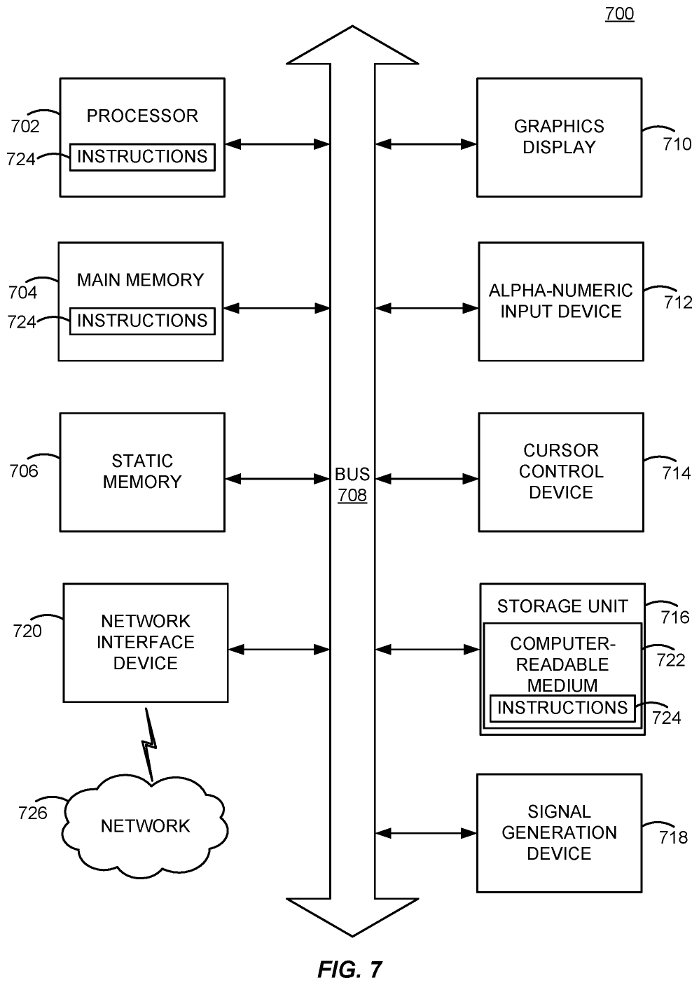

The data sources 110 may involve any kinds of computing devices. Examples of such computing devices include personal computers (PC), desktop computers, laptop computers, tablets (e.g., APPLE iPADs), smartphones, wearable electronic devices such as smartwatches, or any other suitable electronic devices. The data backup clients may be of different natures such as including individual end users, organizations, businesses, and other clients that use different types of client devices (e.g., target devices) that run on different operating systems. The data source 110 may take the form of software, hardware, or a combination thereof (e.g., some or all of the components of a computing machine of FIG. 7).

The data management system 120 may manage data operation cycles (e.g., data backup cycles and restoration cycles) between the data source 110 and the data store 130 and manage metadata of file systems in the data store 130, including scheduling data backup operations. In some embodiments, an operator of the data management system 120 may provide software platforms (e.g., online platforms), software applications that will be installed in the data source 110 (e.g., a background backup application software), application programming interfaces (APIs) for clients to manage backup and restoration of data, etc. In some embodiments, the data management system 120 manages backup data that is stored in the data store 130. For example, the data management system 120 may coordinate the upload and download of backup data between a data source 110 and the data store 130. In this disclosure, data management system 120 may collectively and singularly be referred to as a data management system 120, even though the data management system 120 may include more than one computing device. For example, the data management system 120 may be a pool of computing devices that may be located at the same geographical location (e.g., a server room) or distributed geographically (e.g., cloud computing, distributed computing, or in a virtual server network).

A data operation cycle, such as a backup cycle, may be triggered by an action performed at a data source 110 or by an event, may be scheduled as a regular cycle, or may be in response to an automated task initiated by the data management system 120 to a data source 110. In some embodiments, the data management system 120 may poll a data source 110 periodically and receive files to be backed up and corresponding metadata, such as file names, data sizes, access timestamps, access control information, and the like. In some embodiments, the data management system 120 may perform incremental data operation cycles (e.g., incremental backups) that leverage data from previous data operation cycles to reduce the amount of data to store. The data management system 120 may store the files of the client device as data blocks in the data store 130.

A data operation cycle, such as a backup cycle, may also include de-duplication. A de-duplication operation may include determining a fingerprint of a data block in the snapshot. For example, the fingerprint may be the checksum or a hash of the data block. The data management system 120 may determine that the data store 130 has already stored a data block that has the same fingerprint. In response, the data management system 120 may de-duplicate the data block by not uploading the data block again to the data store 130. Instead, the data management system 120 may create a metadata entry that links the file that includes the duplicated block in the snapshot to the data block that exists in the data store 130. If the data management system 120 determines that the data block's fingerprint is new, the data management system 120 will cause the upload of the data block to the data store 130.

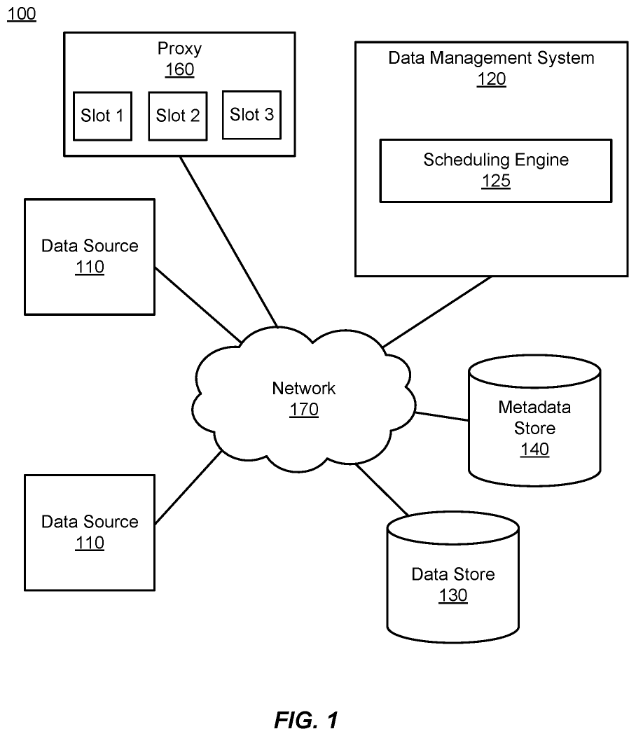

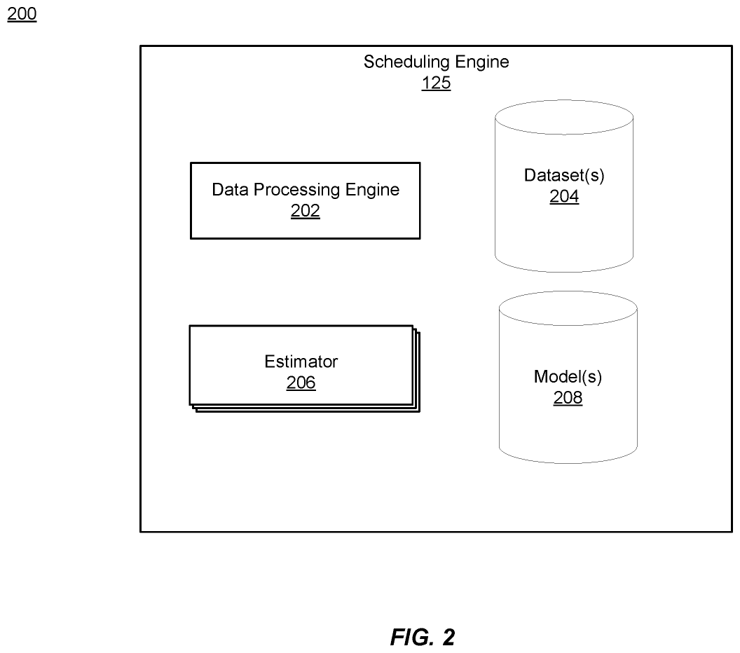

In some embodiments, the data management system 120 may include a scheduling engine 125 that schedules data backups from one or more data sources 110. The scheduling engine 125 may collect configuration data of the data source 110, the data store 130, the network 170 and/or the one or more proxies 160. The scheduling engine 125 may also collect runtime data during data backup that is performed by the one or more proxies 160. The scheduling engine 125 may process and augment the collected data to estimate a scan duration time for backing up data. Based on the estimated scan duration time, the scheduling engine 125 schedules the backup operations by mapping the disk to the corresponding proxy and data store. Details of the metadata creation and management will be further discussed in FIG. 2 through FIG. 6.

The data management system 120 may also perform other data operation cycles such as compaction cycles. For example, only certain versions of snapshots may still be active and data in older versions of snapshots are retired or achieved. The data management system 120 may scan for files that are deleted in an older version of the snapshot that is no longer active in a compaction operation.

In some embodiments, a computing device of the data management system 120 may take the form of software, hardware, or a combination thereof (e.g., some or all of the components of a computing machine of FIG. 7). For example, parts of the data management system 120 may be a PC, a tablet PC, a smartphone, an internet of things (IoT) appliance, or any machine capable of executing instructions that specify actions to be taken by that machine. Parts of the data management system 120 may include one or more processing units and memory.

The data store 130 may communicate with a data source 110 via the network 170 for capturing and restoring files of the data source 110. The data store 130 may also work with the data management system 120 to cooperatively perform data management of data related to the data source 110. The data store 130 may include one or more data storage units such as memory that may take the form of non-transitory and non-volatile computer storage medium to store various data. In some embodiments, the data store 130 may also be referred to as a cloud storage server. Examples of cloud storage service providers may include AMAZON AWS, DROPBOX, RACKSPACE CLOUD FILES, AZURE BLOB STORAGE, GOOGLE CLOUD STORAGE, etc. In other cases, instead of cloud storage servers, the data store 130 may be a storage device that is controlled and connected to the data management system 120. For example, the data store 130 may be memory (e.g., hard drives, flash memory, disks, tapes, etc.) used by the data management system 120.

The data store 130 may include one or more file systems that store various data (e.g., files of data sources 110 in various backups) in one or more suitable formats. For example, the data store 130 may use different data storage architectures to manage and arrange the data. A file system defines how an individual computer or system organizes its data, where the computer stores the data, and how the computer monitors where each file is located. A file system may include directories and/or addresses. In some embodiments, the file system may take the form of an object storage system and manage data as objects. In some embodiments, the file system may manage data as blocks within sectors and tracks. With block storage, files are split into blocks (evenly sized or not) of data, each with its own address. Block storage may be used for most applications, including file storage, snapshot storage, database storage, virtual machine file system (VMFS) volumes, etc. In the context of backup, the file system may also be referred to as a backup file system.

The metadata store 140 may include metadata for the data store 130 in various levels, such as file system level, snapshot level, file level, and block level. Metadata is data that describes data (whether at file system level, snapshot level, and/or file level). Examples of metadata include timestamps, version identifiers, file directories including timestamps of edit or access dates, add and carry logical (ACL) checksums, journals including timestamps for change event, create version, modify version, compaction version, and delete version.

Metadata in the metadata store 140 may include a file system usage record, snapshot records, and data records. The file system usage record may include metadata such as a total-size counter, Uₜ, for the data store 130. The total-size counter may represent the sum of the data size in the file system. The file system usage record may include usage statistics that are stored in a database (e.g., a NoSQL) since this type of database may provide the functionality to atomically increment integer attributes. The snapshot records may include metadata of the snapshots, such as timestamps when the snapshots are captured, backup set identifiers, and increment-size counters that each represents the increase in the data size that is measured through a data operation cycle. The data records may include metadata that describes information about the files.

While the data store 130 and the metadata store 140 are illustrated as separate components in FIG. 1, in some embodiments, the data store 130 and the metadata store 140 may be operated as the same storage. For example, in some embodiments, the data store 130 may include a file system and the metadata store 140 together as a single data store. In other embodiments, the data store 130 and the metadata store 140 are separate.

A proxy 160 may be a component that facilitates data operations between a data source 110 and a data store 130 as an intermediary for moving data and enabling efficient and reliable data transfer. A proxy 160 may take various suitable forms and the location or placement of the proxy 160 in an enterprise data backup environment may vary depending on the backup architecture of the enterprise and depending on embodiments. For example, a proxy 160 may be a local proxy that resides with an enterprise, a remote proxy that is geographically distributed from the data source 110, a virtual proxy that may take the form a virtual machine in an external server, a Cloud proxy, etc. One or more proxies 160 may be hosted on a server. Each server may be identified with a server identifier, and a server identifier list includes a list of servers that host the proxies. In some embodiments, the one or more proxies 160 is deployed within a customized environment within which the backup operations are performed. In the system environment 100, there can be a plurality of proxies. Each proxy may include a plurality of proxy slot, such as Slot 1, Slot 2, Slot 3, etc., as shown in FIG. 1. Each proxy slot may perform a backup operation on one disk in a data store. For example, with a proxy having 6 proxy slots, 6 data backup operations may run in parallel in this proxy. In some embodiments, the data management system 120 may serve as a server that hosts one or more proxies 160.

In system environment 100, the data management system 120 communicates with the data source 110, data store 130, metadata store 140, one or more proxies 160 through the network 170. More than one backup operations may be performed on different proxy slots on the same or different proxies, and different proxies may be hosted by the same or different servers. In the meanwhile, data from more than one disks require to be backed up to more than one data stores. The data management system 120 estimates the backup status of each component and schedules the data backup operations based on the estimation, e.g., an estimated scan duration time.

The communications among the data source 110, the data management system 120, the data store 130, metadata store 140, and proxy 160 may be transmitted via a network 170, for example, via the Internet. The network 170 provides connections to the components of the system environment 100 through one or more sub-networks, which may include any combination of local area and/or wide area networks, using both wired and/or wireless communication systems. In some embodiments, a network 170 uses standard communications technologies and/or protocols. For example, a network 170 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 170 may be represented using any suitable format, such as hypertext markup language (HTML), extensible markup language (XML), or JSON. In some embodiments, all or some of the communication links of a network 170 may be encrypted using any suitable technique or techniques such as secure sockets layer (SSL), transport layer security (TLS), virtual private networks (VPNs), Internet Protocol security (IPsec), etc. The network 170 also includes links and packet switching networks such as the Internet.

### Example Scheduling Engine and Estimator

FIG. 2 is a block diagram that illustrates an example architecture of a scheduling engine 125, in accordance with some embodiments. The scheduling engine 125 receives data backup request for backing up data from one or more data sources 110 (e.g., disks) to data stores 130. The scheduling engine 125 collects data associated with the data sources, data stores, network, proxies, and use the collected data to estimate a scan duration time for the backup operations. Based on the estimated scan duration time, the scheduling engine 125 schedules the backup operations by mapping the disk to the corresponding proxy and data store.

The scheduling engine 125 may include a data processing engine 202, one or more datasets 204, one or more estimators 206, and one or more models 208. The architecture illustrated in FIG. 2 is only an example. In various embodiments, the scheduling engine 125 may include fewer, additional, or different components.

The data processing engine 202 may collect static configuration data of the data source 110, the data store 130, the network 170 and the one or more proxies 160 and the corresponding runtime data during backup operations. The collected data may be stored as telemetry data in the datasets 204. The data processing engine 202 may process and augment the collected data for monitoring and estimating the process of the data backup operations.

In one example, a proxy 160 is performing a data backup operation on the data stored in a disk of a data source 110. The data processing engine 202 may collect the telemetry data of the backup operation during the backup process. For example, the telemetry data may be collected at a 5-minute interval, creating a data point in every 5 minutes. The collected telemetry data may indicate that in the first 5 min interval, the size of the scanned data is 100 GB, out of which the size of changed data is 100 GB, and the percent of changed data (e.g., change ratio) is 100%; in the second 5 minute interval, the size of the scanned data is 200 GB, out of which the size of changed data is 100 GB, and the percent of changed data is 50%. Based on the collected data points in the telemetry data, the data processing engine 202 may aggregate and fuse the data points to augment the telemetry data so as to monitor and estimate the data backup process. In this example, assuming a disk includes 300 GB data to be backed up, out of which the size of changed data is about 200 GB, the data processing engine 202 may estimate the time to complete a backup operation on this disk is about 10 minutes. The data processing engine 202 may perform aggregation based on any number of adjacent data points. For instance, the data processing engine 202 may aggregate every two adjacent data points e.g., data points collected at two adjacent time intervals, to obtain an augmented data.

In some embodiments, the data processing engine 202 may process the telemetry data to obtain processed backup data, for example, by using rollup metrics across all possible combinations of adjacent based statistic intervals of individual backup operations. In one implementation, the statistic interval may refer to an interval frequency at which the telemetry data is collected. For example, the telemetry data may be collected in every 100 s, 200 s, or 300 s. In another example, the statistic interval may be less than 5 minutes. The obtained processed backup data may include Block Scan Count, Block Read Count, Block Fresh Count, Block Upload MBytes, Read Latency Mean, Upload Latency Mean, Stat Interval Secs, etc. The Block Scan Count may refer to the number of data blocks that have been scanned. The Block Read Count may refer to the number of data blocks that have been read, which may be used to calculate parameters such as, sum(Block Read MBytes), change ratio, etc. The Block Fresh Count may be used to calculate the number of deduplicated data block, e.g., sum(Block Dedup Count), by subtracting sum(Block Fresh Count) from sum(Block Read Count). The data processing engine 202 may further calculate a Dedup Ratio which is a ratio between sum(Block Dedup Count) and sum(Block Read Count). The data processing engine 202 may use Block Upload Mbytes to calculate sum(Block Fresh MBytes) and Compression Ratio (e.g., the ratio between sum(Block Upload MBytes) and sum(Block Fresh MBytes)). Additionally, the data processing engine 202 calculates a ratio between sum(Read Latency Sum) and sum(Block Read Count) as Read Latency Mean, and a ratio between sum(Upload Latency Sum) and sum(Block Upload Count) as Upload Latency Mean. Here, latency may be used to describe the time between the start of an operation and the completion of the operation.

In some embodiments, the data processing engine 202 may process the telemetry data that is associated with the data store 130 to obtain processed storage data, for example, by using rollup metrics across backup operations over the same statistic intervals with the same data source, or the same disk on the same data store 130. The obtained processed storage data may include one or more of: Read Latency Mean(storage, proxy), Read Throughput(storage, proxy), Backups Count(storage, proxy), Backups Count(proxy), Read Throughput(storage, global), Backups Count(storage, global). For example, the data processing engine 202 may calculate Read Latency Mean(storage, proxy) by calculating a ratio between sum(Read Latency Sum) and sum(Block Read Count) and performing rollup over all backups on the same proxy using the calculated ratio.

Similarly, the data processing engine 202 may process the telemetry data that is associated with the network 170 to obtain processed network data, for example, by using rollup metrics across overlapping based statistic intervals, i.e., the telemetry data is observed at overlapping intervals. The obtained processed network data may include one or more of: Upload Latency Mean(proxy), Upload Throughput(proxy), Backups Count(proxy), Upload Throughput(global), and Backups Count(global). For example, the data processing engine 202 may calculate Upload Latency Mean(proxy) by calculating a ratio between sum(Upload Latency Sum) and sum(Block Upload Count) and performing rollup over all backups on the same proxy using the calculated ratio.

The datasets 204 include the collected telemetry data and the processed data. The telemetry data may include static configuration data and runtime data. The static configuration data may include parameters that describe the configuration of the data source 110, the data store 130, the network 170 and/or the proxies 160. For example, a server identifier list includes a list of servers on which the proxies are running; and a proxy identifier list includes a list of proxies that can perform the backup operations. The number of slots per proxy describes the number of backup operations that can run in parallel on each proxy, since each proxy slot performs one backup operation. Additionally, the static configuration data may include proxy server mapping that describes the paring between the proxies and the servers.

The runtime data may include runtime configuration data collected during a backup operation on a specific disk. For example, the runtime data may include a disk identifier, a proxy identifier identifying the proxy used to perform the backup operation on the disk, a server identifier identifying the server that runs the proxy used to backup the disk, and a storage identifier identifying the storage that hosts the disk under the backup operation.

The processed data may be calculated based on runtime data collected during previous backup operations, e.g., with static intervals. As discussed above, the datasets 204 may also include the processed backup data, processed storage data, and the processed network data.

The estimators 206 estimate the status of the data source 110, the data store 130, the network 170 and/or the proxies 160 for the scheduling engine 125 to schedule data backup operations. The estimator 206 may include a range of lower level estimators which come together in various ways to build higher level estimators. For example, the estimators Disk Change Estimator and Disk Dedup Estimators can be used by the Scan Duration Estimator which is further used by the Schedule Duration Estimator to estimate a duration time to complete a backup operation. A Performance Curve Estimator may model the storage and network behavior under varying degrees of backup load, and the output can be further used in higher level estimators such as available bandwidth estimators, differential dark load estimators, etc.

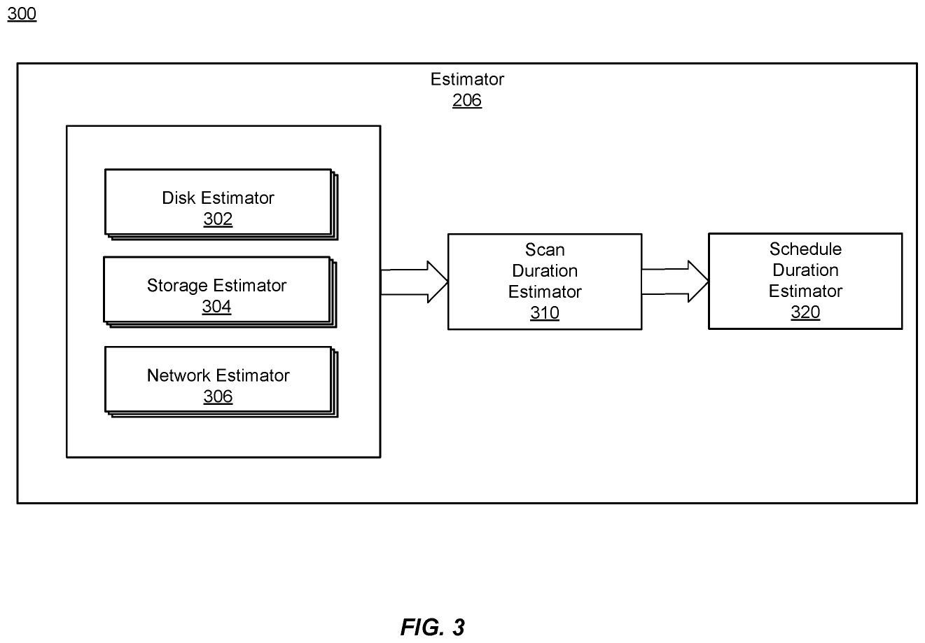

FIG. 3 is a block diagram that illustrates an example architecture 300 of an estimator 206, in accordance with some embodiment. The estimators 206 may include one or more disk estimators 302, one or more storage estimators 304, one or more network estimators 306, a scan duration estimator 310, and a schedule duration estimator 320. The architecture illustrated in FIG. 3 is only an example. In various embodiments, the estimator 206 may include fewer, additional, or different components.

The disk estimators 302 estimate disk information of one or more disks on which the backup operations to be performed. The disk estimators 302 may further include a plurality of estimators, such as a disk size estimator, a disk change estimator, a disk dedup estimator, a disk compression estimator, etc. A disk size estimator estimates a scan block count or a total block count for a disk.

A disk change estimator estimates the number of changed block for a disk. For example, the disk change estimator may estimate the changed block count based on the previous data, e.g., calculating an average count for the last few scans, using time series modeling methods, etc. Alternatively, the disk change estimator may use actual runtime data during the backup process to estimate the changed block count. In one implementation, the disk change estimator may snapshot the disk as a separate or a pre-backup step and query the changed block count using the disk snapshot API (Application Programming Interface). In some embodiments, the disk change estimator may cache a bit-vector of the changed blocks if a pre-backup step is performed. In another implementation, the disk change estimator may estimate the changed block count based on the storage API.

A disk dedup estimator estimates a block deduplication ratio for a disk. A disk dedup estimator may estimate the block deduplication ratio based on past data. For example, the disk dedup estimator may calculate an average block deduplication ratio based on the last few scans or all previous scans. Alternatively, the disk dedup estimator may use actual runtime data (e.g., the data scanned thus far) during the backup process to estimate the block deduplication ratio.

A disk compression estimator estimates a block compression ratio for a disk. A disk compression estimator may estimate the block compression ratio based on past data. For example, the disk compression estimator may calculate an average block compression ratio based on the last few scans or all previous scans. Alternatively, the disk compression estimator may use actual runtime data (e.g., the data scanned thus far) during the backup process to estimate the block compression ratio.

The storage estimators 304 estimate the storage information of one or more storages (e.g., data stores 130) on which the backed-up data is stored. The storage estimators 304 may include a plurality of estimators, such as, a storage performance estimator, a storage performance curve estimator, a storage available bandwidth estimator, a storage differential dark load estimator, a storage performance degradation estimator, a storage bandwidth overload estimator, etc.

In some embodiments, the storage performance estimator estimates storage performance based on a storage bandwidth allocation and the processed storage data. The parameters used by the storage performance estimator may include estimated variables and observed variables. For example, the estimated variables may include Read Latency Mean(storage, proxy), Read Throughput(storage, proxy), etc. The observed variables may include one or more of Available Bandwidth(storage), Backups Count(storage, proxy), Backups Count(proxy), and Backups Count(storage, global).

In some embodiments, the storage performance estimator estimates storage performance based given recent performance and active backup counts. For example, the storage performance estimator may use data from two adjacent statistic intervals from the processed storage data and assumes the unobserved load on storage is the same across adjacent statistic intervals. The estimated variables may include Latency Mean(storage, proxy) in one interval and Read Throughput(storage, proxy) in one interval. The observed variables may include one or more of Backups Count(storage, proxy) in one interval, Backups Count(proxy) in one interval, Backups Count(storage, global) in one interval, Read Latency Mean(storage, proxy) in other interval, Read Throughput(storage, proxy) in other interval, Backups Count(storage, proxy) in other interval, Backups Count(proxy) in other interval, Read Throughput(storage, global) in other interval, and Backups Count(storage, global) in other interval. In some embodiments, the storage performance estimator may be used in a live mode to predict the performance based on recent past data.

The storage performance curve estimator estimates the latency-throughput performance curve of a storage. In some embodiments, the storage performance curve estimator may use data from all backups across all proxies from the given storage, restrict the data backup operation over a certain time range, adjust the data to ensure sufficient data for estimation, and use data across backups and across time from the processed storage data. The parameters used by the storage performance curve estimator may include Read Latency Mean(storage, proxy) and Read Throughput(storage, global). In one implementation, the storage performance curve estimator may fit the parameters with a 5th (or higher) order polynomial to the lower boundary of the scatterplot of the data. The storage available bandwidth estimator estimates the storage bandwidth using the estimated storage performance. In some embodiments, the storage available bandwidth estimator receives the storage performance curve from the storage performance curve estimator as input and determines whether the highest order coefficient is negative. If the highest order coefficient is negative, the estimated bandwidth is an unknown value and is higher than the maximum observed throughput, the storage available bandwidth estimator may also determine that the throughput (T) on the performance curve with a slope greater than a configurable theta. If the throughput (T) is greater than the maximum observed throughput by a configurable delta, then the estimated bandwidth is an unknown value and higher than the maximum observed throughput. The storage available bandwidth estimator may determine the storage bandwidth as the throughput (T).

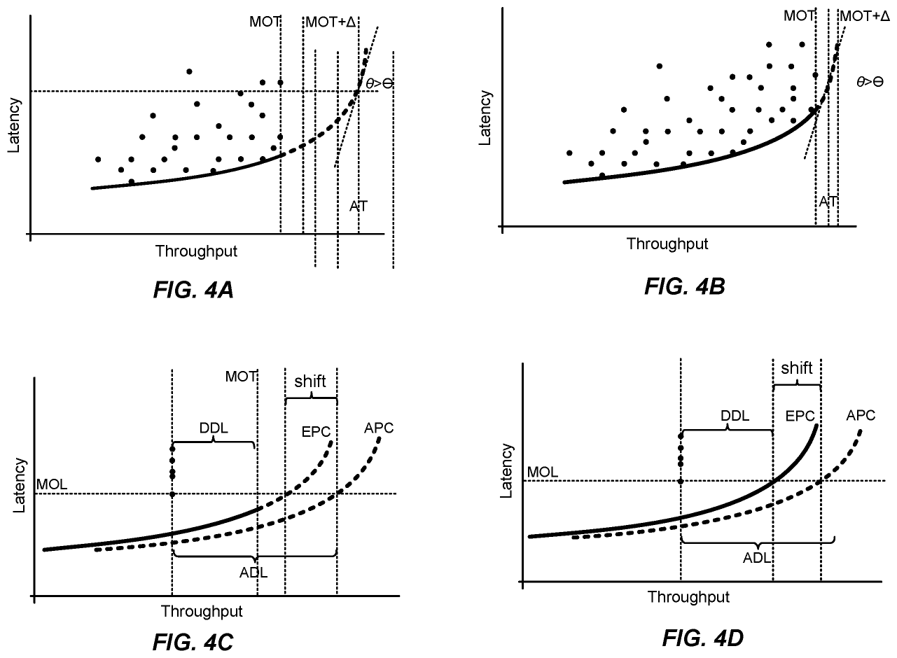

FIG. 4A illustrates an example available bandwidth estimator, in accordance with some embodiments. As shown in FIG. 4A, the available bandwidth is unknown when the asymptotic throughput (AT) exceeds the maximum observed throughput (MOT) by more than a configurable delta.

FIG. 4B illustrates another example available bandwidth estimator, in accordance with some embodiments. As shown in FIG. 4B, the available bandwidth may be estimated as the asymptotic throughput (AT) when it is less than the maximum observed throughput (MOT) plus a configurable delta.

The storage differential dark load estimator estimates the unobserved load (e.g., dark load) on a storage using the estimated storage performance curve. For example, given a recently observed tuple, Read Latency Mean(storage, proxy) and Read Throughput(storage, global), the storage differential dark load estimator may estimate the Read Throughput(storage, universe) and/or the Read Throughput(storage, dark). In one implementation, the storage differential dark load estimator reads the value on the performance curve corresponding to the observed Read Latency Mean(storage, proxy) and selects the Read Latency Mean(storage, proxy) on the proxy with the least throughput, and obtains Read Throughput(storage, universe) which captures both observed/global and unobserved/dark throughput. In another implementation, the storage differential dark load estimator estimates Read Throughput(storage, dark) by subtracting Read Throughput(storage, global) from Read Throughput(storage, universe).

FIG. 4C illustrates an example differential dark load estimator, in accordance with some embodiments. As shown in FIG. 4C, the differential dark load (DDL) at a given time may be estimated as the difference between the throughput at the time and the maximum observed throughput (MOT) when the expected performance curve is not defined at the minimum observed latency (MOL). The actual dark load (ADL) may be not estimable as the actual performance curve (APC) is not available.

FIG. 4D illustrates another example differential dark load estimator, in accordance with some embodiments. As shown in FIG. 4D, the DDL at a given time may be estimated as the difference between the throughput at the time and the through put on the expected performance curve (EPC) that corresponds to the minimum observed latency (MOL). The actual dark load (ADL) is not estimable as the actual performance curve (APC) is not available.

Referring back to FIG. 3, the storage performance degradation estimator estimates whether the storage performance has degraded over time. In some embodiments, the storage performance degradation estimator uses the estimated available storage bandwidth performance as an input and determines whether the current available bandwidth (CAB) estimate is a known value. In some embodiments, the cached previous available bandwidth (PAB) exists and the CAB is below PAB by some delta; the performance is known to have degraded; else, the performance is known not to have degraded. In some embodiments, the CAB is above PAB, the storage performance degradation estimator caches the CAB as the available bandwidth for future comparisons (as PAB). In some other embodiments, the cached PAB does not exist, the storage performance degradation estimator caches CAB as the available bandwidth for future comparisons (as PAB). In still other embodiments, the CAB is not a known value, the storage performance degradation estimator determines the performance is not known to have degraded.

The storage bandwidth overload estimator estimates whether the storage is overloaded using the estimated storage available bandwidth. In one example, the storage bandwidth overload estimator uses the estimated storage performance curve and the estimated available storage as input and determines whether the available bandwidth is unknown. In one embodiment, the available bandwidth is unknown, and the storage bandwidth overload estimator determines the network is not known to be overloaded. In another example, the storage bandwidth overload estimator determines the cutoff latency on the performance curve corresponding to the available bandwidth and determines whether the observed Upload Latency Mean is below the cutoff latency minus some delta. If storage bandwidth overload estimator determines the observed Upload Latency Mean is below the cutoff latency minus some delta, the network is known not to be overloaded; otherwise, the network is known to be overloaded.

The network estimators 306 estimate the network information of the network 170 for a data backup operation. The network estimators 306 may include a plurality of estimators, such as, a network performance estimator, a network performance curve estimator, a network available bandwidth estimator, a network differential dark load estimator, a network performance degradation estimator, a network bandwidth overload estimator, etc.

In some embodiments, the network performance estimator estimates network performance based on a network bandwidth allocation and the processed network data. The parameters used by the network performance estimator may include estimated variables and observed variables. For example, the estimated variables may include upload Latency Mean(proxy), upload Throughput(proxy), etc. The observed variables may include one or more of Available Bandwidth, Backups Count(proxy), and Backups Count(global).

In some embodiments, the network performance estimator estimates network performance based given recent performance and active backup counts. For example, the network performance estimator may use data from two adjacent statistic intervals from the processed network data and assumes the unobserved load on network is the same across adjacent statistic intervals. The estimated variables may include Latency Mean(proxy) in one interval and Read Throughput(proxy) in one interval. The observed variables may include one or more of Backups Count(proxy) in one interval, Backups Count(global) in one interval, Upload Latency Mean(proxy) in other interval, Upload Throughput(proxy) in other interval, Backups Count(proxy) in other interval, Upload Throughput(global) in other interval, and Backups Count(global) in other interval. In some embodiments, the network performance estimator may be used in a live mode to predict the performance based on recent past data.

The network performance curve estimator estimates the latency-throughput performance curve of the network. In some embodiments, the network performance curve estimator may use data from all backups across all proxies, restrict the data backup operation over a certain time range, adjust the data to ensure sufficient data for estimation, and use data across backups and across time from the processed network data. The parameters used by the network performance curve estimator may include Upload Latency Mean(proxy) and Upload Throughput(global). In one implementation, the network performance curve estimator may fit the parameters with a 5th (or higher) order polynomial to the lower boundary of the scatterplot of the data.

The network available bandwidth estimator estimates the network bandwidth using the estimated network performance. In some embodiments, the network available bandwidth estimator receives the network performance curve from the network performance curve estimator as input and determines whether the highest order coefficient is negative. If the highest order coefficient is negative, the estimated bandwidth is an unknown value and is higher than the maximum observed throughput, the network available bandwidth estimator may also determine that the throughput (T) on the performance curve with a slope greater than a configurable theta. If the throughput (T) is greater than the maximum observed throughput by a configurable delta, then the estimated bandwidth is an unknown value and higher than the maximum observed throughput. The network available bandwidth estimator may determine the network bandwidth as the throughput (T).

The network differential dark load estimator estimates the unobserved load (e.g., dark load) on the network using the estimated network performance curve. For example, given a recently observed tuple, Upload Latency Mean(proxy) and Upload Throughput(global), the network differential dark load estimator may estimate the Upload Throughput(universe) and/or the Upload Throughput(dark). In one implementation, the network differential dark load estimator reads the value on the performance curve corresponding to the observed Upload Latency Mean(proxy) and selects the Upload Latency Mean(proxy) on the proxy with the least throughput and obtains Upload Throughput(universe) which captures both observed/global and unobserved/dark throughput. In another implementation, the network differential dark load estimator estimates Upload Throughput(dark) by subtracting Upload Throughput(global) from Upload Throughput(universe).

The network performance degradation estimator estimates whether the network performance has degraded over time. In some embodiments, the network performance degradation estimator uses the estimated available network bandwidth performance as an input and determines whether the current available bandwidth (CAB) estimate is a known value. In some embodiments, the cached previous available bandwidth (PAB) exists and the CAB is below PAB by some delta; the performance is known to have degraded; else, the performance is known not to have degraded. In some embodiments, the CAB is above PAB, the network performance degradation estimator caches the CAB as the available bandwidth for future comparisons (as PAB). In some other embodiments, the cached PAB does not exist, the network performance degradation estimator caches CAB as the available bandwidth for future comparisons (as PAB). In still other embodiments, the CAB is not a known value, the network performance degradation estimator determines the performance is not known to have degraded.

The network bandwidth overload estimator estimates whether the network is overloaded using the estimated network available bandwidth. In one example, the network bandwidth overload estimator uses the estimated network performance curve and the estimated available network as input and determines whether the available bandwidth is unknown. In one embodiment, the available bandwidth is unknown, and the network bandwidth overload estimator determines the network is not known to be overloaded. In another example, the network bandwidth overload estimator determines the cutoff latency on the performance curve corresponding to the available bandwidth and determines whether the observed Upload Latency Mean is below the cutoff latency minus some delta. If network bandwidth overload estimator determines the observed Upload Latency Mean is below the cutoff latency minus some delta, the network is known not to be overloaded; otherwise, the network is known to be overloaded.

The scan duration estimator 310 estimates a backup completion time for a given disk and environmental conditions. As shown in FIG. 3, the scan duration estimator 310 receives outputs from the disk estimators 302, the storage estimators 304, and/or the network estimators 306 as input and estimate a completion time for a data backup operation. The parameters used by the scan duration estimator 310 may include one or more estimated variables and one or more observed variables. In some embodiments, the estimated variables may include Scan Duration. The observed variables may include one or more of Block Scan Count, Block Read Count, Block Fresh Count, Block Upload Mbytes, Read Latency Mean(storage, proxy), Read Throughput(storage, proxy), Upload Latency Mean(proxy), and Upload Throughput(proxy).

The schedule duration estimator 320 estimates a time to complete all backup operations given the proxy count. As shown in FIG. 3, the schedule duration estimator 320 receives the output from one or more of the disk estimators 302, the storage estimators 304, the network estimators 306 and the scan duration estimator 310 as input to calculate a completion time for all backup operations. In some embodiments, the schedule duration estimator 320 may access the datasets 204 and one or more models 208 for performing estimation. In one implementation, the schedule duration estimator 320 takes the output from the scan duration estimator 310 as an input and selects a proxy slot based on the estimated scan duration time as the backup proxy slot for a disk. For example, the schedule duration estimator 320 may select a proxy slot having the lowest scan duration time as the backup proxy slot for the disk.

Referring back to FIG. 2, the models 208 include various algorithms, statistical model, and machine learning models. The data processing engine 202 may use the models 208 to process the telemetry data, and the estimators 206 may use the models 208 to perform estimations. For example, a performance curve estimator may use time series modeling to estimate the storage and network behavior under varying degrees of backup load. In one example, the models 208 may include a scheduling algorithm that is a function or callable entity to perform the scheduling of the backup operations. In some embodiments, the models 208 may include a machine learning model, and the scheduling engine 125 applies the machine learning model to the collected data for performing estimations.

### Example Machine Learning Models

In various embodiments, a wide variety of machine learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used. For example, various data processing performed by the data processing engine 202, estimations performed by the estimators 206, and other processes may apply one or more machine learning and deep learning techniques.

In various embodiments, the training techniques for a machine learning model may be supervised, semi-supervised, or unsupervised. In supervised learning, the machine learning models may be trained with a set of training samples that are labeled. For example, for a machine learning model trained to scan duration time for a backup operation, the training samples may be various historical backup data. The labels for each training sample may be binary or multi-class. In some embodiments, the training labels may also be multi-class such as values of scan duration time.

By way of example, the training set may include multiple past records with known outcomes. Each training sample in the training set may correspond to a past and the corresponding outcome may serve as the label for the sample. A training sample may be represented as a feature vector that include multiple dimensions. Each dimension may include data of a feature, which may be a quantized value of an attribute that describes the past record. For example, in a machine learning model that is used to estimate a scan duration time, the features in a feature vector may include the variables discussed in the previous sections, such as, network performance parameters, storage performance parameters, disk parameters, etc. In various embodiments, certain pre-processing techniques may be used to normalize the values in different dimensions of the feature vector.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In some embodiments, in estimating the scan duration time, the objective function may correspond to minimization/optimization the scan duration time for a particular disk-proxy-data store path as well as the total scan duration time for all the backup operations. In various embodiments, the error rate may be measured as cross-entropy loss, L1 loss (e.g., the sum of absolute differences between the predicted values and the actual value), L2 loss (e.g., the sum of squared distances).

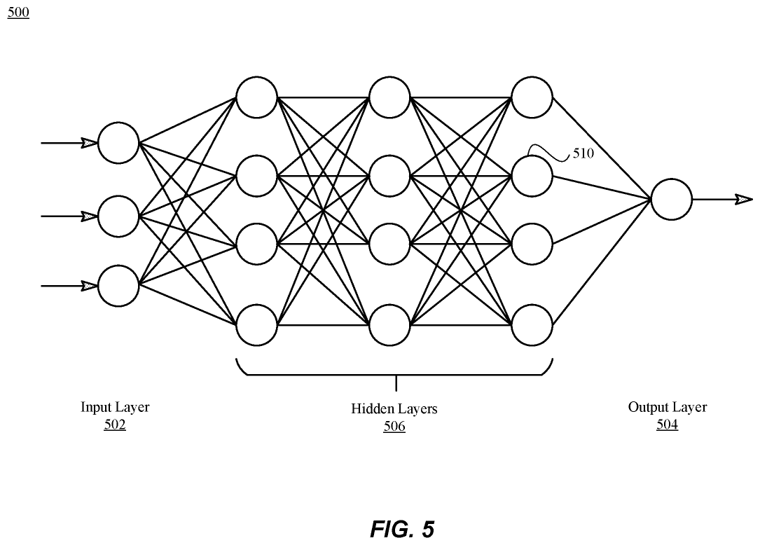

Referring to FIG. 5, a structure of an example neural network is illustrated, in accordance with some embodiments. The neural network 500 may receive an input and generate an output. The input may be the feature vector of a training sample in the training process and the feature vector of an actual case when the neural network is making an inference. The output may be 500 the prediction, classification, or another determination performed by the neural network. The neural network 500 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layer and pooling layer may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one embodiment, one or more custom layers may also be presented for the generation of a specific format of the output. For example, a custom layer may be used for image segmentation for labeling pixels of an image input with different segment labels.

The order of layers and the number of layers of the neural network 500 may vary in different embodiments. In various embodiments, a neural network 500 includes one or more layers 502, 504, and 506, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine learning model may include certain layers, nodes 510, kernels and/or coefficients. Training of a neural network, such as the NN 500, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine learning model may include an iterative process that includes iterations of making determinations, monitoring the performance of the machine learning model using the objective function, and backpropagation to adjust the weights (e.g., weights, kernel values, coefficients) in various nodes 510. For example, a computing device may receive a training set that includes telemetry data. Each training sample in the training set may be assigned with labels indicating a scan duration time. The computing device, in a forward propagation, may use the machine learning model to generate predicted scan duration time. The computing device may compare the predicted scan duration time with the labels of the training sample. The computing device may adjust, in a backpropagation, the weights of the machine learning model based on the comparison. The computing device backpropagates one or more error terms obtained from one or more loss functions to update a set of parameters of the machine learning model. The backpropagating may be performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for performing estimations on the backup operations or another suitable task for which the model is trained.

### Example Usage Data Backup Scheduling Process

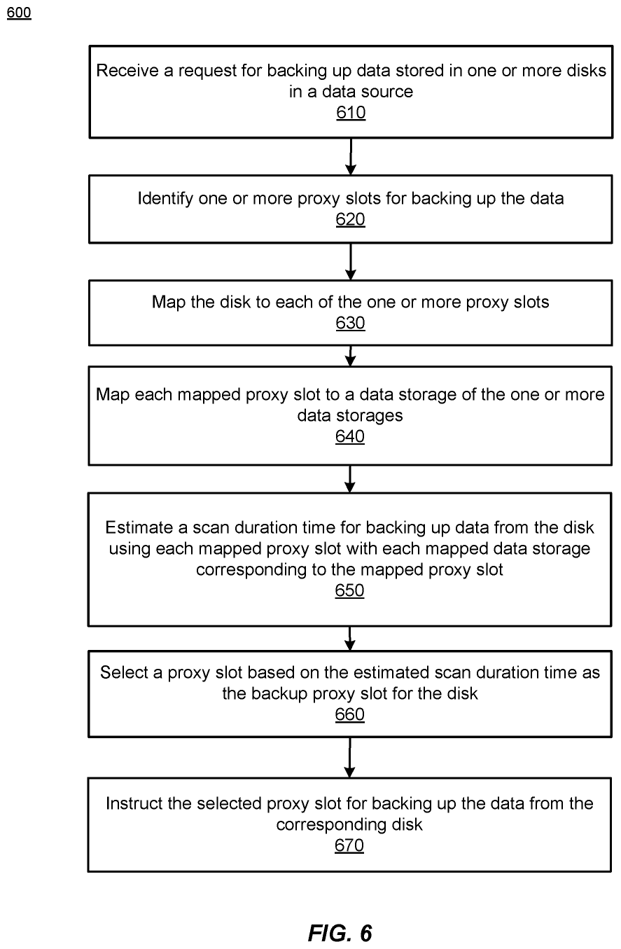

FIG. 6 is a flowchart depicting an example process 600 for scheduling data backup, in accordance with some embodiments. The process 600 may be performed by the data management system 120 in cooperation with one or more proxies 160 and other components in the system environment 100, such as the metadata store 140. The process 600 may be embodied as a software algorithm that may be stored as computer instructions that are executable by one or more processors. The instructions, when executed by the processors, cause the processors to perform various steps in the process 600.

The data management system 120 may receive 610 a request for backing up data stored in one or more disks in a data source 110. In some embodiments, the request may be sent from the one or more data sources 110. In some embodiments, the data management system 120 may schedule the request to back up data stored in the data sources 110 periodically. In one implementation, prior to scheduling the backup operations, the data management system 120 may initialize the schedule duration time to zero.

The data management system 120 may identify 620 one or more proxy slots for backing up the data. The data management system 120 initializes open proxies that are available for performing the backup operations. Each proxy may include a plurality proxy slots for performing data backup operations. Each proxy slot is configured to perform one backup operation on a disk. The data management system 120 may initialize the open proxy slots from the telemetry data in a static simulation mode and/or from a schedule state in a live simulation mode. In a static simulation mode, the data management system 120 performs offline data analysis and determines the schedule duration for a specific time. In one example, in the static simulation mode, the data management system 120 may initialize the open proxy slots using parameters such as Count(Proxy Identifier List), Backup Slots Per Proxy, etc. In a live simulation mode, the data management system 120 estimates the schedule duration in progress. The data management system 120 may determine, for example, the backup operations that are not completed, the disks that are yet to be scheduled, and estimate a time period that the entire schedule takes to complete.

The data management system 120 may map 630 the disk to each of the one or more proxy slots. The data management system 120 may cue a disk for backup for each open proxy slot. Each proxy slot is configured to perform one backup operation on a single disk. Given the number of available disks and the requested backup operations, the data management system 120 pairs a disk with each open proxy slot, e.g., the mapped proxy slot may be configured to perform the backup operation on the corresponding disk.

In some embodiments, for each disk that is newly cued, the data management system 120 may create estimators to estimate the disk information associated with disk size, disk change, disk deduplication, disk compression, etc. For example, the created estimators may include one or more of disk size estimator, disk change estimator, disk dedup estimator, disk compression estimator, etc. The estimated parameters may include one or more of Block Scan Count, Block Read Count, Block Fresh Count, Block Upload Mbytes.

In some embodiments, for each disk that was cued earlier, the data management system 120 may revise the previous estimates. The estimated parameters may include one or more of Block Scan Count, Block Read Count, Block Fresh Count, Block Upload Mbytes. In one implementation, the data management system 120 may perform the estimation in a static simulation mode. For example, the data management system 120 may revise the estimate by multiplying the last estimated parameter with a ratio. Take Block Scan Count as an example, the revised Block Scan Count equals to the last estimated Block Scan Count times a ratio, and the ratio is calculated as (the last estimate of the scan duration minus the time since last estimate) divided by the last estimate of the scan duration. In another implementation, the data management system 120 may perform the estimation in a live simulation mode. For example, the data management system 120 may revise the estimate by subtracting the parameter since last estimate from the last estimated parameter. Take Block Scan Count as an example, the revised Block Scan Count equals to the last estimated Block Scan Count minus the Block Scan Count since last estimate.

The data management system 120 may map 640 each mapped proxy slot to a data store of the one or more data stores (e.g., data stores 130). A data store is configured to store the backup data. Given the mapping between the proxy slot and the disk, the data management system 120 pairs each proxy slot with each available data store, and the paired data store is configured to receive and store the backup data from the mapped proxy slot. In some embodiments, more than one proxy slots may be mapped to a same data store.

The data management system 120 may estimate 650 a scan duration time for backing up the data from the disk using each mapped proxy slot with each mapped data store corresponding to the mapped proxy slot. As the data management system 120 maps each disk to each available proxy slot and maps the mapped proxy slot to each available data store, the data management system 120 creates various combinations of disk-proxy slot-data store mapping paths.

In some embodiments, the data management system 120 may estimate backup status of each proxy slot-data store mapping path. For example, the data management system 120 may calculate the parameters, such as Backups Count(storage, proxy), Backups Count(proxy), Backups Count(storage, global), etc. In one implementation, the data management system 120 may use the calculated parameters and storage performance estimators to further estimate additional parameters, such as, Read Latency Mean(storage, proxy), Read Throughput(storage, proxy), etc. In some embodiments, the data management system 120 may apply a machine learning model to the calculated backup counts to estimate Read Latency Mean(storage, proxy), Read Throughput(storage, proxy).

In some embodiments, the data management system 120 may estimate backup status across all proxies by calculating parameters, such as, Backups Count(proxy), Backups Count(global), etc. In one implementation, for each proxy, the data management system 120 may use the calculated parameters and network performance estimators to further estimate additional parameters, such as, Upload Latency Mean(proxy), Upload Throughput(proxy), etc. In one implement, the data management system 120 may apply a machine learning model to the calculated backup counts to estimate Upload Latency Mean(proxy), Upload Throughput(proxy) which are associated with the network performance for each mapped proxy slot.

Based on the estimated parameters associated with the backup status of each disk-proxy slot-data store mapping path as well as the combinations of all mapping paths, the data management system 120 may estimate a scan duration time for backing up the data from each disk. For example, the data management system 120 may estimate read latency and read throughput associated with storage performance for each mapped proxy slot and each mapped data store corresponding to the mapped proxy slot. In another example, the data management system 120 may estimate upload latency and upload throughput associated with network performance for each mapped proxy slot. In still another example, the data management system 120 may estimate disk information associated with disk size, disk change, disk de-duplication, and disk compression. The data management system 120 may receive these estimated parameters as input to a scan duration estimator which outputs an estimated scan duration time for backing up the data from a disk.

In some embodiments, the data management system 120 may use the models to perform estimations. For example, the data management system 120 may use time series modeling to estimate the storage and network behavior under varying degrees of backup load. The data management system 120 may use a scheduling algorithm that is a function or callable entity to perform the scheduling of the backup operations.

The data management system 120 may select 660 a proxy slot based on the estimated scan duration time as the backup proxy slot for the disk. In some embodiments, the data management system 120 may select the proxy slot having the lowest scan duration time as the backup proxy.

The data management system 120 may instruct 670 the selected proxy slot for backing up the data from the corresponding disk.

In some embodiments, the data backup request may include a plurality of disks for backup. The data management system 120 may estimate an overall scan duration time for backing up data from all the disks. The overall scan duration time may indicate a time to complete backup operations on all the disks. In some embodiments, the data management system 120 may select proxy slots and data stores based on the estimated overall scan duration time.

### Computing Machine Architecture

FIG. 7 is a block diagram illustrating components of an example computing machine that is capable of reading instructions from a computer readable medium and execute them in a processor. A computer described herein may include a single computing machine shown in FIG. 7, a virtual machine, a distributed computing system that includes multiples nodes of computing machines shown in FIG. 7, or any other suitable arrangement of computing devices.

By way of example, FIG. 7 shows a diagrammatic representation of a computing machine in the example form of a computer system 700 within which instructions 724 (e.g., software, program code, or machine code), which may be stored in a computer readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 7 may correspond to any software, hardware, or combined components shown in FIGS. 1-6, including but not limited to, the data source 110, the data management system 120, the data store 130, the metadata store 140, the proxy 160, and various engines, interfaces, terminals, and machines shown in FIGS. 1-6. While FIG. 7 shows various hardware and software elements, each of the components described in FIGS. 1-6 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 724 that specify actions to be taken by that machine. Further, while only a single machine is illustrated, the term “machine” and “computer” also may be taken to include any collection of machines that individually or jointly execute instructions 724 to perform any one or more of the methodologies discussed herein.

The example computer system 700 includes one or more processors 702 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 700 also may include memory 704 that store computer code including instructions 724 that may cause the processors 702 to perform certain actions when the instructions are executed, directly or indirectly by the processors 702. Memory 704 may be any storage devices including non-volatile memory, hard drives, and other suitable storage devices. Instructions can be any directions, commands, or orders that may be stored in different forms, such as equipment-readable instructions, programming instructions including source code, and other communication signals and orders. Instructions may be used in a general sense and are not limited to machine-readable codes.

One and more methods described herein improve the operation speed of the processors 702 and reduces the space required for the memory 704. For example, the architecture and methods described herein reduce the complexity of the computation of the processors 702 by applying one or more novel techniques that simplify the steps generating results of the processors 702, and reduce the cost of restoring data. The algorithms described herein also reduce the storage space requirement for memory 704.

The performance of certain of the operations may be distributed among the more than processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 700 may include a main memory 704, and a static memory 706, which are configured to communicate with each other via a bus 708. The computer system 700 may further include a graphics display unit 710 (e.g., a plasma display panel (PDP), a liquid crystal display (LCD), a projector, or a cathode ray tube (CRT)). The graphics display unit 710, controlled by the processors 702, displays a graphical user interface (GUI) to display one or more results and data generated by the processes described herein. The computer system 700 also may include alphanumeric input device 712 (e.g., a keyboard), a cursor control device 714 (e.g., a mouse, a trackball, a joystick, a motion sensor, or other pointing instrument), a storage unit 716 (a hard drive, a solid state drive, a hybrid drive, a memory disk, etc.), a signal generation device 718 (e.g., a speaker), and a network interface device 720, which also are configured to communicate via the bus 708.

The storage unit 716 includes a computer readable medium 722 on which is stored instructions 724 embodying any one or more of the methodologies or functions described herein. The instructions 724 also may reside, completely or at least partially, within the main memory 704 or within the processor 702 (e.g., within a processor's cache memory) during execution thereof by the computer system 700, the main memory 704 and the processor 702 also constituting computer readable media. The instructions 724 may be transmitted or received over a network 726 via the network interface device 720.

While computer readable medium 722 is shown in an example embodiment to be a single medium, the term “computer readable medium” should be taken to include a single medium or multiple media (e.g., a centralized or distributed database, or associated caches and servers) able to store instructions (e.g., instructions 724). The computer readable medium may include any medium that is capable of storing instructions (e.g., instructions 724) for execution by the processors (e.g., processors 702) and that causes the processors to perform any one or more of the methodologies disclosed herein. The computer readable medium may include, but not be limited to, data repositories in the form of solid-state memories, optical media, and magnetic media. The computer readable medium does not include a transitory medium such as a propagating signal or a carrier wave.

### ADDITIONAL CONSIDERATIONS

Beneficiary, the data management system described herein provides a system/method that may collect and estimate parameters associated with data backup in both a statistic mode and a live mode. The system may observe dynamic parameters and thus requires a smaller set of historical data. Based on the collected data, the system may estimate the completion time of a running backup operation as well as all configurable backup operations. The system may check overload and/or degradation for the proxy, the server, the storage, and/or the network, monitor the dark load across/over time. In this way, the system may perform dynamic and periodic evaluations of the backup operations and share successful backup patterns across customer environments, and determine a cost efficient scale up and down in compute environments.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g., method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A computer-implemented method for scheduling data backup in one or more data stores for storing data, and the computer-implemented method comprises:
receiving a request for backing up data stored in one or more disks in a data source;
identifying one or more proxy slots for backing up the data; and
for at least one of the disks,
mapping the disk to each of the one or more proxy slots;
mapping each mapped proxy slot to a data store of the one or more data stores;
estimating a scan duration time for backing up data from the disk using each mapped proxy slot with each mapped data store corresponding to the mapped proxy slot;
selecting a proxy slot based in part on the estimated scan duration time as the backup proxy slot for the disk;
instructing the selected proxy slot for backing up the data from the corresponding disk.

2. The computer-implemented method of claim 1, wherein estimating a scan duration time for backing up data from the disk comprises:
estimating read latency and read throughput associated with storage performance for each mapped proxy slot and each mapped data store corresponding to the mapped proxy slot; and
estimating the scan duration time for backing up the data from the disk based in part on the estimated read latency and estimated read throughput.

3. The computer-implemented method of claim 2, wherein estimating the read latency and read throughput comprises:
estimating backup counts for each mapped proxy slot and each mapped data store corresponding to the mapped proxy slot; and
applying a machine learning model to the estimated backup counts to estimate the read latency and read throughput.

4. The computer-implemented method of claim 1, wherein estimating a scan duration time for backing up data from the disk comprises:
estimating upload latency and upload throughput associated with network performance for each mapped proxy slot; and
estimating the scan duration time for backing up the data from the disk based in part on the estimated upload latency and estimated upload throughput.

5. The computer-implemented method of claim 4, wherein estimating the upload latency and upload throughput comprises:
estimating backup counts for the identified proxies slots performing backup operations on all of the one or more disks; and
applying a machine learning model to the estimated backup counts to estimate the upload latency and upload throughput associated with network performance for each mapped proxy slot.

6. The computer-implemented method of claim 1, wherein estimating a scan duration time for backing up data from the disk comprises:
estimating disk information associated with disk size, disk change, disk de-duplication, and disk compression; and
estimating the scan duration time for backing up the data from the disk based in part on the estimated disk information.

7. The computer-implemented method of claim 1, wherein estimating a scan duration time for backing up data from the disk comprises:
estimating backup status of the disk and each mapped proxy slot in a static simulation mode, a live simulation mode, or the combination thereof.

8. The computer-implemented method of claim 1, wherein selecting a proxy slot based in part on the estimated scan duration time as the backup proxy slot for the disk comprises:
selecting a proxy slot having the lowest scan duration time as the backup proxy slot.

9. The computer-implemented method of claim 1, wherein identifying one or more proxy slots for backing up the data comprises:
collecting telemetry data associated with proxy slots configured to perform data backup operations; and
identifying the one or more proxy slots that are available for backing up data from the one or more disks.

10. The computer-implemented method of claim 1, further comprising:
estimating an overall scan duration time for backing up the data from all of the one or more disks; and
selecting backup proxy slots for the one or more disks based on the estimated scan duration time of each disk and the estimated overall scan duration time.

11. A system comprising:
one or more data stores configured to store data;
one or more proxies each comprising a set of proxy slots configured for performing data backup operations;
a data management system in communication with the one or more data stores and the one or more proxies through a network, the data management system configured to:
receive a request for backing up data stored in one or more disks in a data source;
identifying one or more proxy slots for backing up the data; and
for at least one of the disks,
map the disk to each of the one or more proxy slots;
map each mapped proxy slot to a data store of the one or more data stores;
estimate a scan duration time for backing up data from the disk using each mapped proxy slot with each mapped data store corresponding to the mapped proxy slot;
select a proxy slot based in part on the estimated scan duration time as the backup proxy slot for the disk;
instruct the selected proxy slot for backing up the data from the corresponding disk.

12. The system of claim 11, wherein estimating a scan duration time for backing up data from the disk comprises:
estimating read latency and read throughput associated with storage performance for each mapped proxy slot and each mapped data store corresponding to the mapped proxy slot; and
estimating the scan duration time for backing up the data from the disk based in part on the estimated read latency and estimated read throughput.

13. The system of claim 12, wherein estimating the read latency and read throughput comprises:
estimating backup counts for each mapped proxy slot and each mapped data store corresponding to the mapped proxy slot; and
applying a machine learning model to the estimated backup counts to estimate the read latency and read throughput.

14. The system of claim 11, wherein estimating a scan duration time for backing up data from the disk comprises:
estimating upload latency and upload throughput associated with network performance for each mapped proxy slot; and
estimating the scan duration time for backing up the data from the disk based in part on the estimated upload latency and estimated upload throughput.

15. The system of claim 14, wherein estimating the upload latency and upload throughput comprises:
estimating backup counts for the identified proxies slots performing backup operations on all of the one or more disks; and
applying a machine learning model to the estimated backup counts to estimate the upload latency and upload throughput associated with network performance for each mapped proxy slot.

16. The system of claim 11, wherein estimating a scan duration time for backing up data from the disk comprises:
estimating disk information associated with disk size, disk change, disk de-duplication, and disk compression; and
estimating the scan duration time for backing up the data from the disk based in part on the estimated disk information.

17. The system of claim 11, wherein estimating a scan duration time for backing up data from the disk comprises:
estimating backup status of the disk and each mapped proxy slot in a static simulation mode, a live simulation mode, or the combination thereof.

18. The system of claim 11, wherein selecting a proxy slot based in part on the estimated scan duration time as the backup proxy slot for the disk comprises:
selecting a proxy slot having the lowest scan duration time as the backup proxy slot.

19. The system of claim 11, wherein identifying one or more proxy slots for backing up the data comprises:
collecting telemetry data associated with proxy slots configured to perform data backup operations; and
identifying the one or more proxy slots that are available for backing up data from the one or more disks.

20. The system of claim 11, wherein the data management system is configured to:
estimate an overall scan duration time for backing up the data from all of the one or more disks; and
select backup proxy slots for the one or more disks based on the estimated scan duration time of each disk and the estimated overall scan duration time.
